(19) United States
(12) Patent Application Publication
(10) Pub. No.: US 2017/0152975 A1
(43) Pub. Date: Jun. 1, 2017

(54) ROTATABLE CONNECTOR FOR CONNECTING A FLUID TRANSMISSION PIPE

(71) Applicant: YI-CHUAN HUANG, Changhua (TW)

(72) Inventor: YI-CHUAN HUANG, Changhua (TW)

(21) Appl. No.: 14/955,001

(22) Filed: Nov. 30, 2015

(51) Int. Cl. F16L 27/02; F16L 15/08; F16L 13/02

(52) U.S. Cl. CPC F16L 27/02; F16L 13/02; F16L 15/08

(57) ABSTRACT

A rotatable connector for connecting a fluid transmission pipe has simplified structure and is easy to assemble. An inner threaded portion of a first covering ring and an outer threaded section of a second covering ring are screwed with each other, a third plastic ring arranged at a bottom surface of an outer threaded portion of the first covering ring is abutted against a first plastic ring arranged at an end of a barrel having an upper opening, and a fourth plastic ring arranged on an inner shoulder portion of the second covering ring is abutted against a bottom portion of the second convex ring so that the barrel is fastened by the first covering ring and the second covering ring. The barrel is capable for being rotated relative to the first covering ring or the second covering ring due to the smooth plastic material of the plastic rings.

### FIELD OF THE INVENTION

The present invention provides a joint, more particularly to a rotatable connector for connecting a fluid transmission pipe.

### BACKGROUND OF THE INVENTION

Please refer to FIG. 1, the conventional joint 100′ for connecting a fluid transmission pipe 300 is one piece (integrated) or fixed. That is, the elements of the joint 100′ are not movable or rotatable relative to one another. One end of the joint 100′ is fluidly communicated with a reservoir 200 and the other end thereof is fluidly communicated with the fluid transmission pipe 300. The fluid may be oil or water, but not limited thereto.

Since the joint is fixed, the transmission pipe 300 may be twisted to deform and further to become tighter to influence the efficiency of fluid transmission if the reservoir 200 is moved. If the joint is one piece (integrated), it is hard to manufacture and the defect rate may be increased to increase cost.

Please reference to Taiwanese patent no. M364153, it disclosed a movable pipe connector. It comprises a tube, a first joint, and a second joint. An annular concave groove is arranged at an inner annular edge of the second joint. A plurality of balls is received in the annular concave groove. A convex edge is arranged outside of the second joint. The convex edge has a first wall surface which is abutted against the balls so that the second joint may be rotated relative to the tube. Therefore, the second joint may be rotated all-round so that the first joint and the second joint may be not affected with each other to result in twisting, winding, and deforming. It may make sure that inside of the tube is free.

Although the movable pipe connector which is mentioned above may prevent from twisting, winding, and deforming to make sure inside of the tube is free, the assembly of the elements, such as the balls, is complicated and uneasy. The production capacity and the yield rate may be influenced and further the cost may be also influenced.

### SUMMARY OF THE INVENTION

An objective of this invention is providing a rotatable connector for connecting a fluid transmission pipe, which has simplified structure and is easy to assemble. Besides, the inner threaded portion of the first covering ring and the outer threaded section of the second covering ring are screwed with each other, the third plastic ring arranged at the bottom surface of the outer threaded portion of the first covering ring is abutted against and contacted with the first plastic ring arranged at the end of the barrel which has the upper opening, and the fourth plastic ring arranged on the inner shoulder portion of the second covering ring is abutted against a bottom portion of the second convex ring so that the barrel is fastened by the first covering ring and the second covering ring. And then, the barrel is capable for being rotated relative to the first covering ring or the second covering ring due to the smooth plastic material (such as Teflon) of the first plastic ring, the second plastic ring, the third plastic ring, and the fourth plastic ring.

Furthermore, the outer threaded portion of the first covering ring may be screwed and fluidly communicated with a fluid reservoir for receiving oil or water, and the connection groove of the barrel may fluidly communicated with the fluid transmission pipe. Therefore, when the outer threaded portion of the first covering ring is screwed in or out the fluid reservoir, the fluid transmission pipe may be not deformed and further not become tight to influence the fluid transmission while being twisted. The efficiency of fluid transmission may be improved.

To achieve above objectives, a rotatable connector for connecting a fluid transmission pipe is disclosed and comprises a barrel, having a hollow and cylindrical body, a first convex ring, and a second convex ring, the body has an inner wall surface, an outer wall surface, an upper opening, and a lower opening arranged opposite to the upper opening, the first convex ring is extended upwardly from the inner wall surface adjacent to the upper opening, and the second convex ring is extended outwardly from the outer wall surface and arranged adjacent to the upper opening; a first plastic ring, arranged on one end of the barrel having the upper opening, an inner diameter of the first plastic ring is equal to an outer diameter of the first convex ring so that the first plastic ring is covered outside of the first convex ring; a second plastic ring, covered at an outer side wall of the barrel adjacent to the upper opening, a bottom portion of the second plastic ring is abutted against a top portion of the second convex ring, and an outer diameter of the second plastic ring is larger than an outer diameter of the second convex ring; a first covering ring, having an outer threaded portion and an inner threaded portion fluidly communicated with each other, an outer diameter of the outer threaded portion is smaller than an outer diameter of the inner threaded portion, an inner convex ring is extended inwardly from the connection of the outer threaded portion and the inner threaded portion, a concave ring groove is concavely formed at a bottom surface of the outer threaded portion for receiving a third plastic ring, the first covering ring is covered at the end of the barrel having the upper opening, the end of the barrel adjacent to the upper opening is supported a bottom end of the outer threaded portion, the third plastic ring is arranged corresponding to and contacted with the first plastic ring, and an inner diameter of the inner threaded portion is larger than the outer diameter of the second convex ring; and a second covering ring, having an outer threaded section and an inner shoulder portion, an inner diameter of the outer threaded section is equal to the outer diameter of the second plastic ring, the second covering ring is covered outside of the barrel, the outer threaded section and the inner threaded portion of the first covering ring are screwed with each other, the inner shoulder portion is arranged below the second convex ring, an inner diameter of the inner shoulder portion is smaller than the outer diameter of the second convex ring, and a fourth plastic ring is arranged on the inner shoulder portion and interposed between the inner shoulder portion and the second convex ring; wherein the inner threaded portion of the first covering ring and the outer threaded section of the second covering ring are screwed with each other, the third plastic ring arranged at the bottom surface of the outer threaded portion of the first covering ring is abutted against and contacted with the first plastic ring arranged at the end of the barrel having the upper opening, and the fourth plastic ring arranged on the inner shoulder portion of the second covering ring is abutted against a bottom portion of the second convex ring so that the barrel is fastened by the first covering ring and the second covering ring, and then the barrel is capable for being rotated relative to the first covering ring or the second covering ring due to the smooth plastic material of the first plastic ring, the second plastic ring, the third plastic ring, and the fourth plastic ring.

In some embodiments, a transverse section of an outer wall surface of the inner threaded portion is octagonal, and a transverse section of an inner wall surface of the inner threaded portion is circular.

In some embodiments, the barrel further includes a connection groove concavely surrounded the outer wall surface adjacent to the lower opening.

In some embodiments, the first plastic ring, the second plastic ring, and the fourth plastic ring are made by Teflon.

In some embodiments, the inner threaded portion of the first covering ring and the outer threaded section of the second covering ring are welded together after being screwed.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a view of a conventional joint for connecting a fluid transmission pipe while being applied.

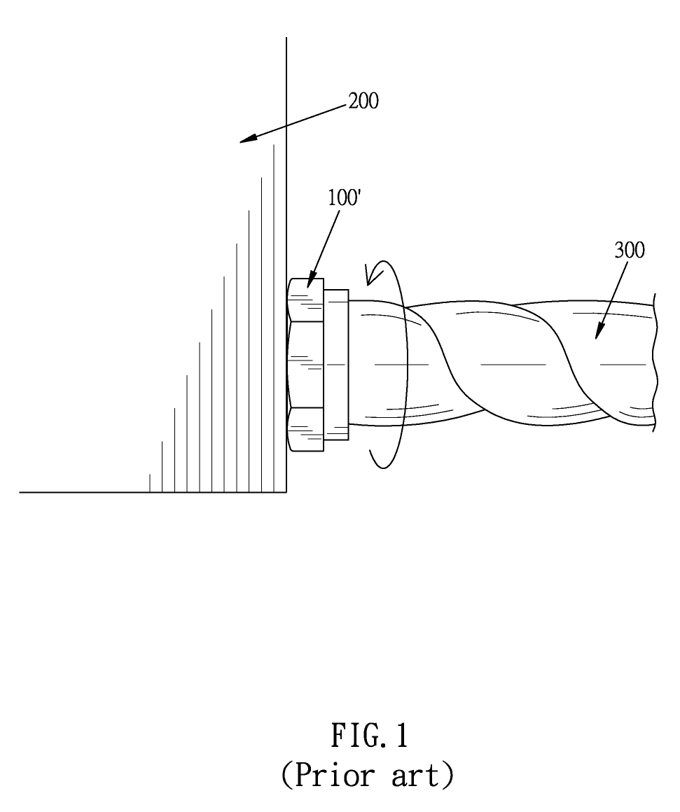

FIG. 2 is an exploded view of a rotatable connector for connecting a fluid transmission pipe according to present invention.

FIG. 3 is a perspective view of the rotatable connector according to present invention.

FIG. 4 is a cross-sectional view of FIG. 3 along line A-A;

FIG. 5 is a partial cross-sectional view of the rotatable connector according to present invention.

FIG. 6 is an operational view of the rotatable connector according to present invention.

FIG. 7 is a view of the rotatable connector according to present invention while being applied.

### DESCRIPTION OF THE PREFERRED EMBODIMENT

Referring now to the drawings where like characteristics and features among the various figures are denoted by like reference characters.

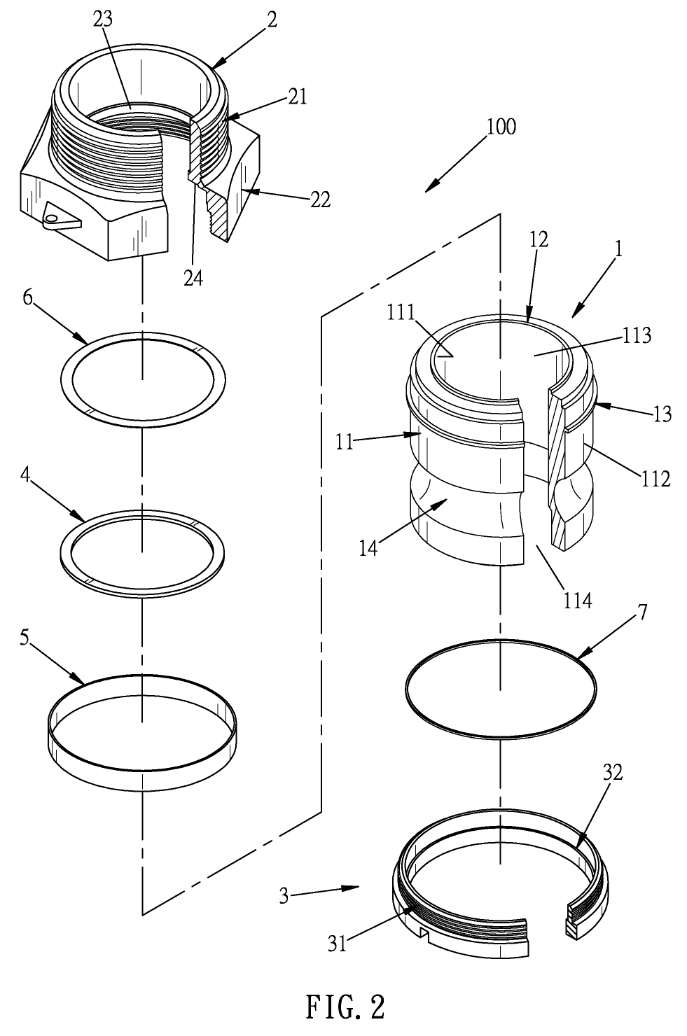

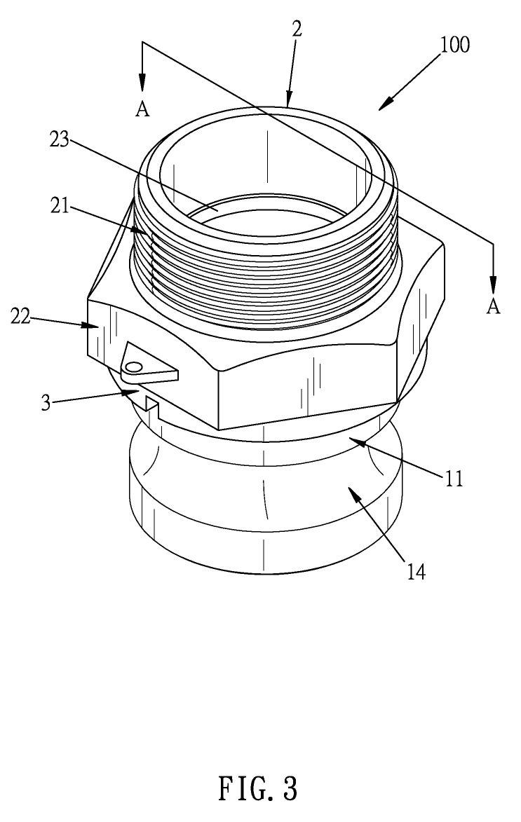

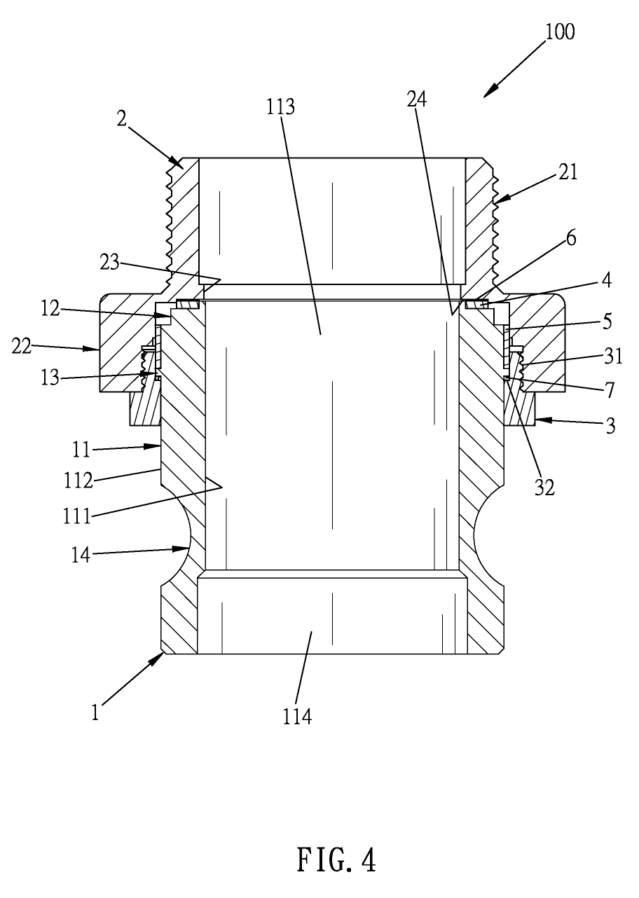

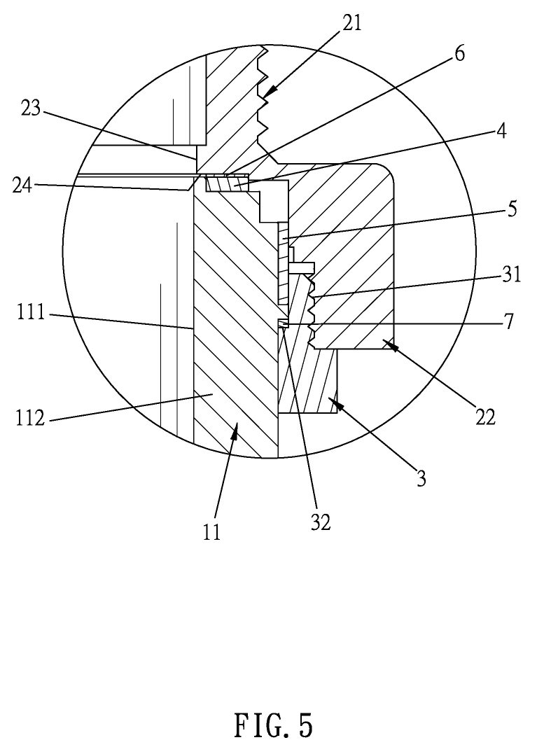

Please refer to FIGS. 2 to 7, the rotatable connector 100 for a fluid transmission pipe 300 of the present invention may comprise a barrel 1, a first plastic ring 4, a second plastic ring 5, a first covering ring 2, and a second covering ring 3.

The barrel 1 may have a hollow and cylindrical body 11, a first convex ring 12, and a second convex ring 13. The body 11 has an inner wall surface 111, an outer wall surface 112, an upper opening 113, and a lower opening 114 arranged opposite to the upper opening 113. The first convex ring 12 is extended upwardly from the inner wall surface 111 adjacent to the upper opening 113. The second convex ring 13 is extended outwardly from the outer wall surface 112 and arranged adjacent to the upper opening 113.

In addition, the barrel 1 may further include a connection groove 14. The connection groove 14 is concavely surrounded the outer wall surface 112 adjacent to the lower opening 114.

The first plastic ring 4 may be arranged on one end of the barrel 1 which has the upper opening 113. An inner diameter of the first plastic ring 4 is equal to an outer diameter of the first convex ring 12 so that the first plastic ring 4 may be covered outside of the first convex ring 12.

The second plastic ring 5 may be covered at an outer side wall of the barrel 1 which is adjacent to the upper opening 113. A bottom portion of the second plastic ring 5 is abutted against a top portion of the second convex ring 13. An outer diameter of the second plastic ring 5 is larger than an outer diameter of the second convex ring 13.

The first covering ring 2 may have an outer threaded portion 21 and an inner threaded portion 22 fluidly communicated with each other. An outer diameter of the outer threaded portion 21 is smaller than an outer diameter of the inner threaded portion 22. An inner convex ring 23 is extended inwardly from the connection of the outer threaded portion 21 and the inner threaded portion 22. A concave ring groove 24 is concavely formed at a bottom surface of the outer threaded portion 21 for receiving a third plastic ring 6. The first covering ring 2 is covered at the end of the barrel which has the upper opening 113. The end of the barrel 1 which is adjacent to the upper opening 113 is supported a bottom end of the outer threaded portion 21. The third plastic ring 6 is arranged corresponding to and contacted with the first plastic ring 4. An inner diameter of the inner threaded portion 22 is larger than the outer diameter of the second convex ring 13. In this embodiment, a transverse section of an outer wall surface of the inner threaded portion 22 is octagonal and a transverse section of an inner wall surface of the inner threaded portion 22 is circular, but not limited thereto.

The second covering ring 3 may have an outer threaded section 31 and an inner shoulder portion 32. An inner diameter of the outer threaded section 31 is equal to the outer diameter of the second plastic ring 5. The second covering ring 3 is covered outside of the barrel 1. The outer threaded section 31 and the inner threaded portion 22 of the first covering ring 2 are screwed with each other to be fastened. The inner shoulder portion 32 is arranged below the second convex ring 13. An inner diameter of the inner shoulder portion 32 is smaller than the outer diameter of the second convex ring 13. A fourth plastic ring 7 is arranged on the inner shoulder potion 32 and interposed between the inner shoulder portion 32 and the second convex ring 13.

The inner threaded portion 22 of the first covering ring 2 and the outer threaded section 31 of the second covering ring 3 are welded together after being screwed so as to prevent the fluid from leaking. The fluid may be oil, water, and etc.

According to above mentioned structure and descriptions, the rotatable connector 100 of the present invention has simplified structure and is easy to assemble. Besides, the inner threaded portion 22 of the first covering ring 2 and the outer threaded section 31 of the second covering ring 3 are screwed with each other, the third plastic ring 6 arranged at the bottom surface of the outer threaded portion 21 of the first covering ring 2 is abutted against and contacted with the first plastic ring 4 arranged at the end of the barrel 1 which has the upper opening 113, and the fourth plastic ring 7 arranged on the inner shoulder portion 32 of the second covering ring 3 is abutted against a bottom portion of the second convex ring 13 so that the barrel 1 is fastened by the first covering ring 2 and the second covering ring 3. And then, the barrel 1 is capable for being rotated relative to the first covering ring 2 or the second covering ring 3 due to the smooth plastic material (such as Teflon, but not limited thereto) of the first plastic ring 4, the second plastic ring 5, the third plastic ring 6, and the fourth plastic ring 7.

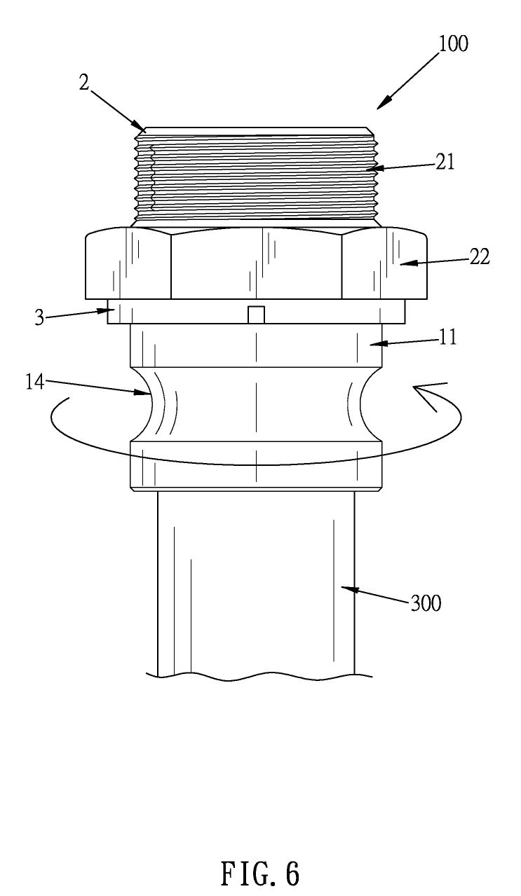

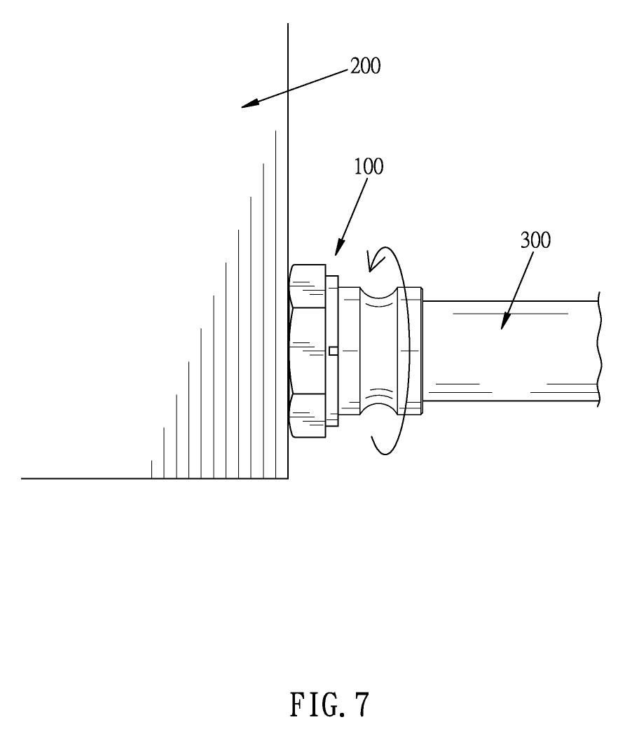

Please refer to FIGS. 6 and 7, the outer threaded portion 21 of the first covering ring 2 may be screwed and fluidly communicated with a fluid reservoir 200 for receiving oil or water, and the connection groove 14 of the barrel 1 may fluidly communicated with the fluid transmission pipe 300. Therefore, when the outer threaded portion 21 of the first covering ring 2 is screwed in or out the fluid reservoir 200, the fluid transmission pipe 300 may be not deformed and further become tight to influence the fluid transmission while being twisted. The efficiency of fluid transmission may be improved.

What is claimed is:

1. A rotatable connector for connecting a fluid transmission pipe, comprising:
a barrel, having a hollow and cylindrical body, a first convex ring, and a second convex ring, the body has an inner wall surface, an outer wall surface, an upper opening, and a lower opening arranged opposite to the upper opening, the first convex ring is extended upwardly from the inner wall surface adjacent to the upper opening, and the second convex ring is extended outwardly from the outer wall surface and arranged adjacent to the upper opening;
a first plastic ring, arranged on one end of the barrel having the upper opening, an inner diameter of the first plastic ring is equal to an outer diameter of the first convex ring so that the first plastic ring is covered outside of the first convex ring;
a second plastic ring, covered at an outer side wall of the barrel adjacent to the upper opening, a bottom portion of the second plastic ring is abutted against a top portion of the second convex ring, and an outer diameter of the second plastic ring is larger than an outer diameter of the second convex ring;
a first covering ring, having an outer threaded portion and an inner threaded portion fluidly communicated with each other, an outer diameter of the outer threaded portion is smaller than an outer diameter of the inner threaded portion, an inner convex ring is extended inwardly from the connection of the outer threaded portion and the inner threaded portion, a concave ring groove is concavely formed at a bottom surface of the outer threaded portion for receiving a third plastic ring, the first covering ring is covered at the end of the barrel having the upper opening, the end of the barrel adjacent to the upper opening is supported a bottom end of the outer threaded portion, the third plastic ring is arranged corresponding to and contacted with the first plastic ring, and an inner diameter of the inner threaded portion is larger than the outer diameter of the second convex ring; and
a second covering ring, having an outer threaded section and an inner shoulder portion, an inner diameter of the outer threaded section is equal to the outer diameter of the second plastic ring, the second covering ring is covered outside of the barrel, the outer threaded section and the inner threaded portion of the first covering ring are screwed with each other, the inner shoulder portion is arranged below the second convex ring, an inner diameter of the inner shoulder portion is smaller than the outer diameter of the second convex ring, and a fourth plastic ring is arranged on the inner shoulder portion and interposed between the inner shoulder portion and the second convex ring;
wherein the inner threaded portion of the first covering ring and the outer threaded section of the second covering ring are screwed with each other, the third plastic ring arranged at the bottom surface of the outer threaded portion of the first covering ring is abutted against and contacted with the first plastic ring arranged at the end of the barrel having the upper opening, and the fourth plastic ring arranged on the inner shoulder portion of the second covering ring is abutted against a bottom portion of the second convex ring so that the barrel is fastened by the first covering ring and the second covering ring, and then the barrel is capable for being rotated relative to the first covering ring or the second covering ring due to the smooth plastic material of the first plastic ring, the second plastic ring, the third plastic ring, and the fourth plastic ring.

2. The rotatable connector as claimed in claim 1, wherein a transverse section of an outer wall surface of the inner threaded portion is octagonal, and a transverse section of an inner wall surface of the inner threaded portion is circular.

3. The rotatable connector as claimed in claim 1, wherein the barrel further includes a connection groove concavely surrounded the outer wall surface adjacent to the lower opening.

4. The rotatable connector as claimed in claim 1, wherein the first plastic ring, the second plastic ring, and the fourth plastic ring are made by Teflon.

5. The rotatable connector as claimed in claim 1, wherein the inner threaded portion of the first covering ring and the outer threaded section of the second covering ring are welded together after being screwed.
